(19) United States
(12) Patent Application Publication
(10) Pub. No.: US 2019/0171299 A1
(43) Pub. Date: Jun. 6, 2019

(54) INFORMATION PROCESSING APPARATUS, DISPLAY APPARATUS, AND INFORMATION PROCESSING SYSTEM

(71) Applicant: FUJI XEROX CO., LTD., Tokyo (JP)

(72) Inventors: Hirotake SASAKI, Kanagawa (JP); Hirohito SHIBATA, Kanagawa (JP); Naoki HIJI, Kanagawa (JP)

(73) Assignee: FUJI XEROX CO., LTD., Tokyo (JP)

(21) Appl. No.: 16/198,893

(22) Filed: Nov. 23, 2018

(30) Foreign Application Priority Data
Dec. 4, 2017 (JP) 2017-232518

(51) Int. Cl. G06F 3/03; G06F 3/0354; G06F 3/01

(52) U.S. Cl. CPC G06F 3/0321; G06F 3/017; G06F 3/03545

(57) ABSTRACT

An information processing apparatus includes an image information acquisition unit and a generation unit. The image information acquisition unit acquires image information of an input unit, from an imaging apparatus that captures the input unit by which information is input. The generation unit generates display information for a display apparatus that displays an image of the input unit based on the image information. The generation unit updates the display information for the display apparatus, according to information which is input by using the input unit displayed on the display apparatus.

### CROSS-REFERENCE TO RELATED APPLICATIONS

This application is based on and claims priority under 35 USC 119 from Japanese Patent Application No. 2017-232518 filed Dec. 4, 2017.

### BACKGROUND

### (i) Technical Field

The present invention relates to an information processing apparatus, a display apparatus, and an information processing system.

### (ii) Related Art

From the past, a work of generating a document or the like using a paper medium has been generally performed. In order to support or replace this work, attempts to use a virtual space and attempts to use electronic pens that enable electronic handwritten data on paper to be electronically captured have been made.

### SUMMARY

According to an aspect of the invention, there is provided an information processing apparatus including an image information acquisition unit that acquires image information of an input unit, from an imaging apparatus that captures the input unit by which information is input; and a generation unit that generates display information for a display apparatus that displays an image of the input unit based on the image information, wherein the generation unit updates the display information for the display apparatus, according to information which is input by using the input unit displayed on the display apparatus.

### BRIEF DESCRIPTION OF THE DRAWINGS

Exemplary embodiment(s) of the present invention will be described in detail based on the following figures, wherein:

FIG. 1 is a diagram illustrating a configuration of an information processing system according to an exemplary embodiment;

FIG. 2 is a block diagram illustrating an example of functional configurations of an information processing apparatus and a display apparatus according to the present exemplary embodiment;

FIGS. 3A and 3B are diagrams showing a method of determining the position and attitude of an input unit, based on image information of a marker;

FIG. 4A is a diagram showing a case where a sheet and a pen tip of a pen are in contact with each other. FIG. 4B is a diagram showing a case where a sheet and a hand of a user are in contact with each other;

FIGS. 5A and 5B are diagrams showing additional information;

FIG. 6 is a flowchart for explaining an operation of the information processing system;

FIG. 7 is a flowchart for explaining a process in which a determination unit determines the position and attitude of the input unit or the like, based on the position of the marker;

FIG. 8 is a flowchart for explaining a process of detecting that a sheet and a pen are in contact with each other, as plural input units;

FIG. 9 is a flowchart for explaining a process of detecting that the input unit and a user's hand are in contact with each other;

FIG. 10 is a flowchart for explaining a process of detecting that the sheet and the pen are in contact with each other, by using a contact determination sensor which is provided on the pen tip;

FIG. 11 is a flowchart for explaining a process of detecting that the sheet and the pen are in contact with each other, by using a contact determination sensor which is provided on the sheet; and

FIGS. 12A and 12B are diagrams for comparing a desktop state visually recognized by a user in a real space with a desktop state visually recognized by the user in a virtual space, in the present exemplary embodiment.

### DETAILED DESCRIPTION

Hereinafter, an exemplary embodiment of the present invention will be described in detail with reference to the accompanying drawings.

Description of Entire Information Processing System

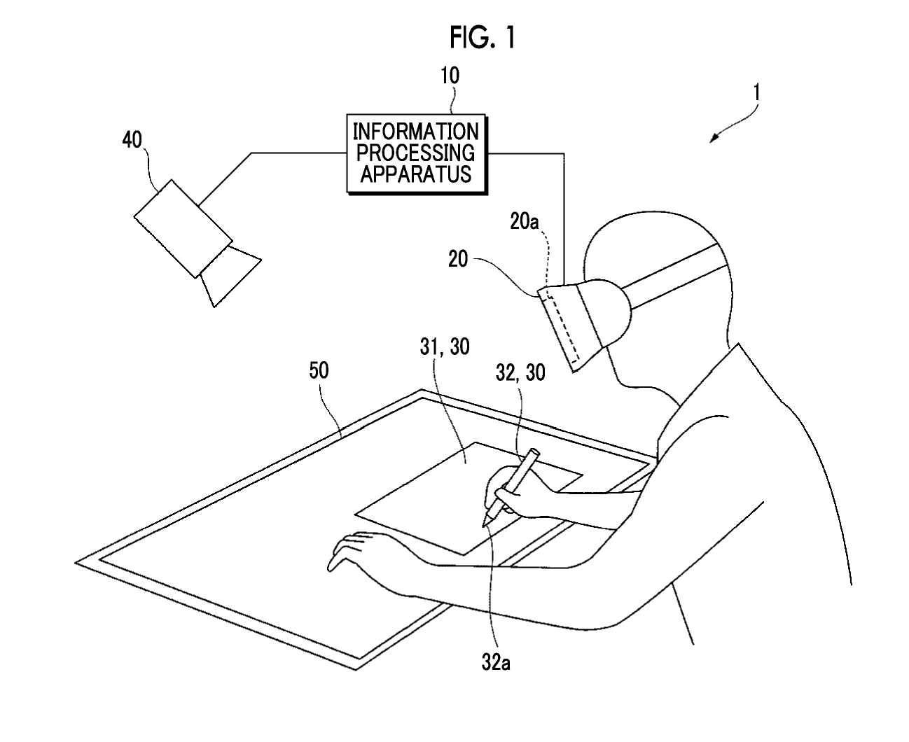

FIG. 1 is a diagram illustrating a configuration example of an information processing system according to an exemplary embodiment.

As shown in FIG. 1, an information processing system 1 of the present exemplary embodiment includes an information processing apparatus 10 that generates display information, a display apparatus 20 that displays an image based on the display information, an input unit 30 by which information is input, a camera 40 that captures an image of the input unit 30, and an area setting sheet 50 indicating a range in which the user performs a work by using the input unit 30.

The information processing apparatus 10 is, for example, a so-called general purpose personal computer (PC). Then, the information processing apparatus 10 causes various application software to be executed, under the control of an operating system (OS), so that information processing of the present exemplary embodiment or the like is performed.

The information processing apparatus 10 includes a central processing unit (CPU) which is a computing unit, and a main memory and a hard disk drive (HDD) which are storage units. Here, the CPU executes various software such as an operating system (OS), basic software, and application program (application software). The main memory is a storage area for storing various software and data used for its execution, and the HDD is a storage area for storing input data for various software, output data from various software, and the like.

Further, the information processing apparatus 10 includes a communication interface for communicating with the outside.

The display apparatus 20 is, for example, a head mounted display (HMD). That is, the user wears the head mounted display on the head and views the image displayed on the display screen 20a disposed in front of the user inside the head mounted display. The display screen 20a is configured with a display having a function of displaying an image, such as a liquid crystal display and an organic electroluminescence display (organic EL display (OELD)).

Although details will be described later, the input unit is not particularly limited as long as it can input information. In the present exemplary embodiment, the input unit 30 includes a sheet-type input unit and a pen-type input unit, as a shape.

The sheet-type input unit 30 is an input device which the user holds and operates like paper. The shape is like a sheet and is rectangular. Further, the size is not particularly limited, and may be the same as or different from the various paper sizes which are generally distributed. Further, for example, a plate-like member which is not flexible and is not easily deformed is preferable. In the sheet-type input unit 30, front and back surfaces are defined. Then, it can be placed stably on the plane of a desk or the like, and the front surface or the back surface can be seen in that state. The sheet-type input unit 30 is, for example, a rectangular plate made of resin or the like. Hereinafter, the sheet-type input unit 30 may be referred to as “sheet 31”.

The pen-type input unit 30 is an input device which the user holds in hand and operates like a pen and which is intended for writing. The shape is like a pen and has a pen tip 32a which is in contact with the sheet-type input unit 30 at its tip. In other words, the pen tip 32a of the pen-type input unit 30 can be brought into contact with the sheet-type input unit 30 to input information such as writing text and figures. The pen-type input unit 30 may be a stylus pen or the like, and may be a pen which can be used for actual writing, such as a ballpoint pen, a pencil, a fountain pen or the like. Hereinafter, the pen-type input unit 30 may be referred to as “pen 32”.

Further, the input unit 30 is not limited to a sheet type or a pen type. For example, it may be a keyboard-type, a mouse-type, a mug-type, or a plastic bottle-type input unit. The keyboard-type input unit 30 has plural keys for inputting information by being pressed down. Therefore, the keyboard-type input unit 30 may be an actual keyboard. A cursor is moved and a button is selected by moving the mouse-type input unit 30. Therefore, the mouse-type input unit 30 may be an actual mouse. The mug-type input unit 30 can contain beverage, and the user can actually drink the beverage. Therefore, the mug-type input unit 30 may be an actual mug. The PET bottle-type input unit 30 is filled with beverage, and the user can actually drink the beverage. Therefore, the PET bottle-type input unit 30 may be an actual PET bottle.

In the present exemplary embodiment, these input units 30 are provided with markers for determining the positions and attitudes of the input units 30. “Marker” is a mark. In the present exemplary embodiment, “marker” is a mark that is disposed in the input unit 30 or the like and is capable of determining the position and attitude of the input unit 30 and the like from the image captured by the camera 40. More specifically, the “marker” is printed on a plane like a one-dimensional barcode or a two-dimensional barcode, for example. Alternatively, light emitting devices such as LEDs may be disposed in a prescribed three-dimensional shape. The attachment position of the marker is predetermined and is held by the information processing apparatus 10. The marker has information of a unique ID number, and can be used for distinguishing each of the input units 30.

The camera 40 is an example of an imaging apparatus, and includes, for example, an optical system that converges incident light and an image sensor that is an imaging unit that detects light converged by the optical system.

The optical system is formed by combining a single lens or plural lenses. In the optical system, various types of aberrations are removed by the combination of lenses, coatings applied on the lens surface, and the like. The image sensor is configured by arranging imaging devices such as a charge coupled device (CCD) and a complementary metal oxide semiconductor (CMOS).

The area setting sheet 50 is an example of an area setting unit, and is a sheet for determining an area in which a work can be performed by using the input unit 30. For example, the area setting sheet 50 is placed on a desk on which the user performs a work, and the input unit 30 is placed on the area setting sheet 50. As will be described in detail later, the area where the area setting sheet 50 is placed is a tactile area where the user performs a work while actually touching and using the input unit 30.

The information processing apparatus 10 and the display apparatus 20 are connected through, for example, a digital visual interface (DVI). Instead of DVI, the information processing apparatus 10 and the display apparatus 20 may be connected through High-Definition Multimedia Interface (HDMI (registered trademark)), DisplayPort, or the like.

Further, the information processing apparatus 10 and the input unit 30 are connected through, for example, universal serial bus (USB). Instead of USB, they may be connected through IEEE 1394, RS-232C or the like. Further, without being limited thereto, it may be a wireless connection such as a wireless local area network (LAN), Bluetooth (registered trademark), or the like.

Further, in the illustrated example, the information processing apparatus 10 and the camera 40 are connected by wires, and are connected through, for example, USB, IEEE 1394, or RS-232C. Thus, the image information of the image imaged by the camera 40 is transmitted to the information processing apparatus 10 by wire. However, the present invention is not limited to this, and the wireless connection described above may be used.

The outline operation of such an information processing system 1 will be described.

First, the user inputs information using the input unit 30 placed on the area setting sheet 50. At this time, the user actually operates the input unit 30 by using the user's hand. Then, the input unit 30 is imaged by the camera 40, and the image information obtained by imaging is transmitted to the information processing apparatus 10. The information processing apparatus 10 generates display information of a screen to be displayed on the display apparatus 20. On the display apparatus 20, an image similar to the real space is displayed in the virtual space. That is, the input unit 30 is virtually displayed in the virtual space. Further, the desk surface on which the input unit is disposed is virtually displayed. Further, the user's hand operating the input unit 30 is virtually displayed. As will be described later in detail, even those not existing in the real space may be displayed in the virtual space. Then, the information input by the user using the input unit 30 is displayed in this virtual space and is updated sequentially.

Here, “real space” is a space in the real world, and “virtual space” is a space representing a world imitating the real world, which is constructed on a computer.

Description of Information Processing Apparatus 10 and Display Apparatus 20

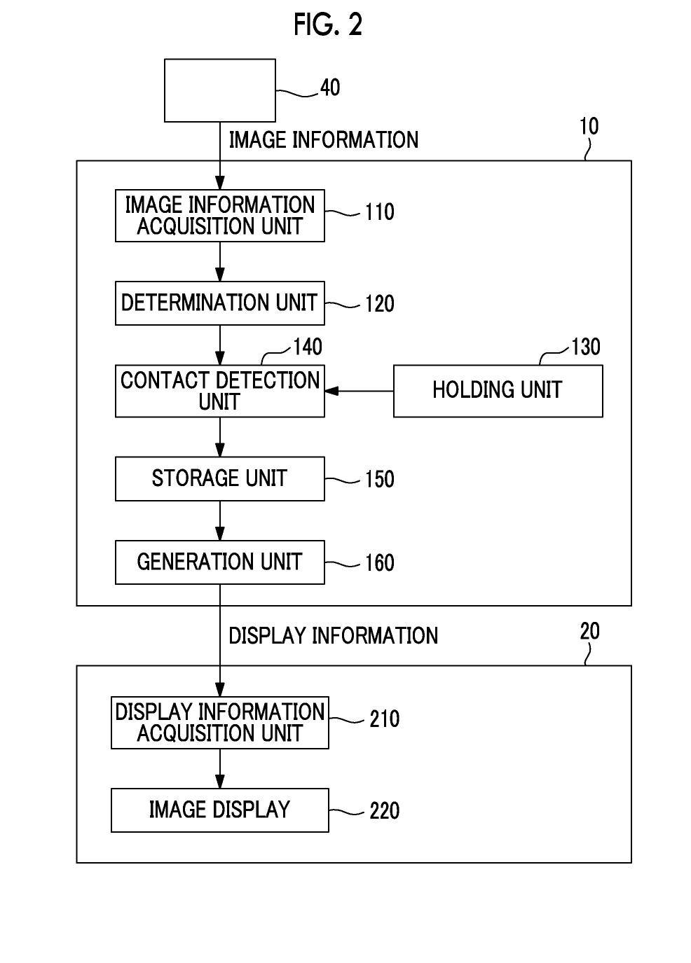

FIG. 2 is a block diagram illustrating an example of a functional configuration of the information processing apparatus 10 and the display apparatus 20 according to the present exemplary embodiment. In FIG. 2, among the various functions of the information processing apparatus 10 and the display apparatus 20, those related to the present exemplary embodiment are selected and shown.

As illustrated, the information processing apparatus 10 according to the present exemplary embodiment includes an image information acquisition unit 110 that acquires image information from the camera 40, a determination unit 120 that determines the positions and attitudes of the input unit 30 and the user's hand, a holding unit 130 that holds the size, shape, and the like of the input unit 30, a contact detection unit 140 that detects that the input units 30 are in contact with each other or the user's hand and the input unit 30 are in contact with each other, a storage unit 150 that stores the information input by the input unit 30, and a generation unit 160 that generates display information to be displayed on the display apparatus 20.

The image information acquisition unit 110 acquires the image information of the input unit 30 from the camera 40 imaging the input unit 30. Further, the image information acquisition unit 110 also acquires the image information of the images of the display apparatus 20, the area setting sheet 50, and the user's hand, which are imaged by the camera 40.

In this case, the camera 40 captures the image of the input unit 30 existing in the real space as shown in FIG. 1. Then, the image information obtained by imaging is transmitted from the camera 40 to the information processing apparatus 10, and acquired by the image information acquisition unit 110. In this case, the image information is image information of a moving image, but it may be image information of plural still images captured at predetermined short time intervals such as every one second, for example.

The determination unit 120 determines the position and attitude of the input unit 30. At this time, the determination unit 120 determines the position and attitude of the input unit 30, based on the image information of the marker captured by the camera 40. With respect to the pen 32, the determination unit 120 further determines the position of the pen tip 32a.

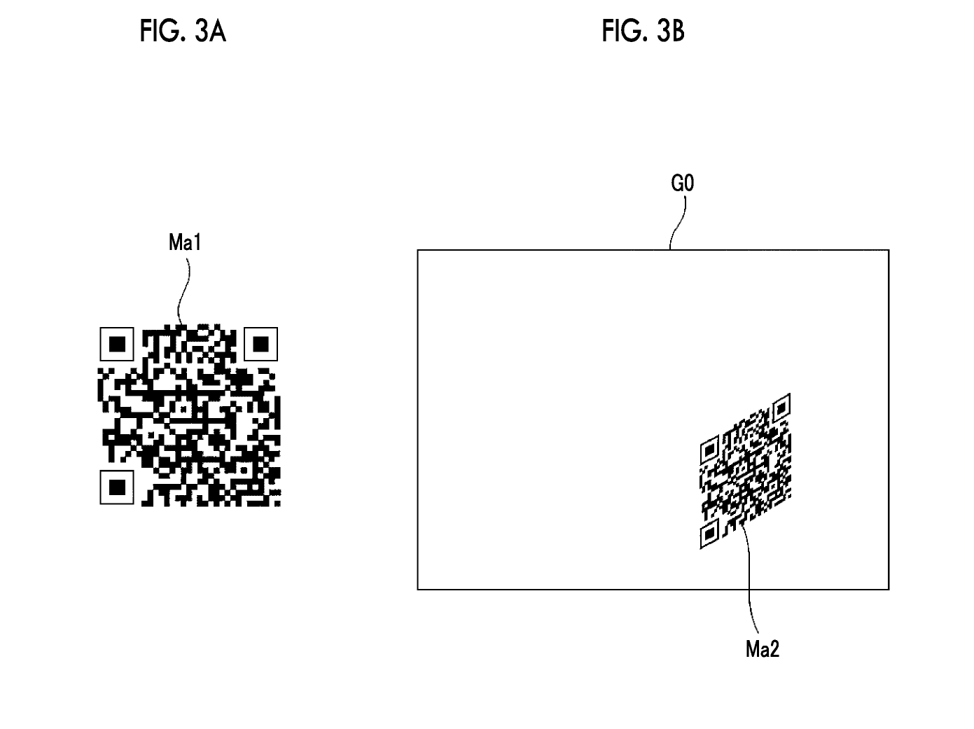

FIGS. 3A and 3B are diagrams showing a method of determining the position and attitude of the input unit 30, based on the image information of the marker. Here, FIG. 3A shows the actual marker Ma1. Further, FIG. 3B shows a marker Ma2 in the image G0 captured by the camera 40. Here, the case where the markers Ma1 and Ma2 are two-dimensional barcodes is shown.

The determination unit 120 compares the actual size of the marker Ma1 shown in FIG. 3A with the size and deformation state of the marker Ma2 in the image G0 captured by the camera 40 shown in FIG. 3B and calculates the distance from the camera 40 to the marker Ma2 and the attitude of the marker Ma2. Thus, the determination unit 120 determines the position and attitude of the input unit 30.

The determination unit 120 also determines the position and attitude of the display apparatus 20 and the area setting sheet 50. In this case, a marker is also provided for the display apparatus 20 and the area setting sheet 50, and the determination unit determines the positions and attitudes of the display apparatus 20 and the area setting sheet 50 based on the image information of the marker captured by the camera 40. Further, the marker has information of a unique ID number, and can be used to recognize the display apparatus 20 or the area setting sheet 50.

Further, the determination unit 120 further determines the position and attitude of the user's hand. In this case, similar to the input unit 30, a marker may be attached to the user's hand, but in reality, it may be difficult. Therefore, here, for example, it is preferable that the shape of the hand is sensed using a three-dimensional measurement device or the like and thus the determination unit 120 calculates the position and attitude of the user's hand. In this case, for example, it is preferable to also determine the joint angle of the finger, and the like, as the determination result of the right hand or the left hand. An ID number is also assigned to the user's hand, so that the user's hand can be recognized. The three-dimensional measuring apparatus is not particularly limited, and commercially available measuring apparatuses can be used. For example, Leap Motion's Leap Motion, Intel's RealSense, Microsoft's Kinect, or the like can be used.

The holding unit 130 holds the size, shape, and the like of the input unit 30 in addition to the ID number of the input unit 30 and the attachment position of the marker. With respect to the display apparatus 20 and the area setting sheet 50, the ID numbers thereof, the attachment position of the marker, the size and shape, and the like are similarly held. Further, the holding unit 130 holds the ID number, size, shape, or the like of the user's hand. With respect to the size and shape, the holding unit 130 holds them as a 3D model. With respect to the pen 32, the holding unit 130 holds range information of the pen tip 32a in the 3D model.

The contact detection unit 140 detects that the plural input units 30 are in contact with each other or the input unit 30 and the user's hand are in contact with each other.

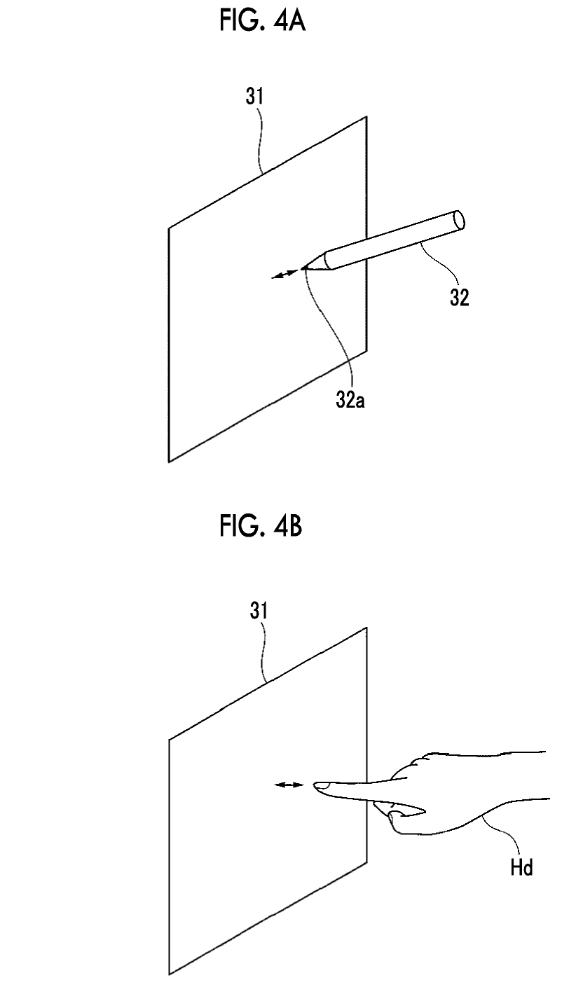

For example, as shown in FIG. 4A, the contact detection unit 140 detects that the sheet 31 and the pen tip 32a of the pen 32 are in contact with each other. In this case, the contact detection unit 140 determines the position of the pen tip 32a and the range of the sheet 31, based on the positions and attitudes of the sheet 31 and the pen 32 determined by the determination unit 120 and the sizes and shapes of the sheet 31 and the pen 32 held by the holding unit 130. Then, in a case where the position of the pen tip 32a and the range of the sheet 31 are equal to or less than the predetermined distance, the contact detection unit 140 determines that both are in contact. In the case where there are plural sheets 31 and pens 32, the same process is performed for all combinations of these.

For example, as shown in FIG. 4B, the contact detection unit 140 detects that the sheet 31 and the user's hand Hd are in contact with each other. In this case, the contact detection unit 140 determines the input range by the finger, based on the position and attitude of the user's hand Hd determined by the determination unit 120 and the size and shape of the user's hand Hd held by the holding unit 130. Further, the contact detection unit 140 determines the range of the sheet 31, based on the position and attitude of the sheet 31 determined by the determination unit 120 and the size and shape of the sheet 31 held by the holding unit 130. Then, in a case where the input range by the finger and the range of the sheet 31 are equal to or less than the predetermined distance, the contact detection unit 140 determines that both are in contact. In the case where there are plural sheets 31, the same process is performed for the user's hand Hd and all combinations thereof. The input range by the finger is defined as a predetermined range such as the tip portion of the user's index finger.

The user can select whether to perform input manually. That is, the user switches between ON and OFF of the manual input mode. When the input mode is ON, the contact detection unit 140 detects that the sheet 31 and the user's hand Hd are in contact with each other as described above. On the other hand, when the input mode is OFF, the contact between the sheet 31 and the user's hand Hd is not detected.

When the contact detection unit 140 detects a contact, the storage unit 150 stores information input by the input unit 30 or the user's hand Hd as additional information. This is information of handwriting input by the user, for example. The “additional information” is information input by the plural input units 30 being in contact with each other. Further, “additional information” includes information input by the sheet 31 and the user's hand Hd being in contact. The additional information is linked as meta information of the image information acquired by the image information acquisition unit 110.

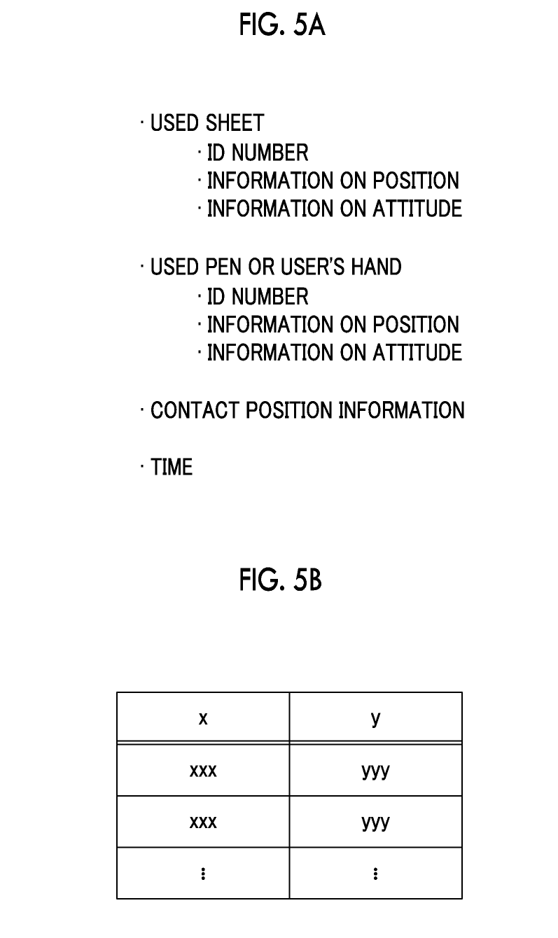

FIGS. 5A and 5B are diagrams showing additional information.

As shown in FIG. 5A, the additional information includes the ID number, information on the position, and information on the attitude of the used sheet 31. The ID number, information on the position, and information on the attitude of the used pen 32 or the user's hand are included. Further, contact position information which is information on a contact position, and information on the time of contact are included. Among them, the contact position information is coordinate data consisting of x and y as shown in FIG. 5B, and represents the coordinates on the surface of the sheet 31 with the center position of the sheet 31 as a reference. With such additional information, it is also possible to reproduce the state in which the user performs an input with the pen 32.

Returning to FIG. 2, the generation unit 160 generates display information for the display apparatus 20 that displays an image of the input unit 30 based on the image information acquired by the image information acquisition unit 110. At this time, the generation unit 160 updates the display information for the display apparatus 20, according to the information which is input by using the input unit 30 displayed on the display apparatus 20. At this time, the generation unit 160 generates display information for virtually displaying the input unit 30 in the virtual space.

At this time, the generation unit 160 generates display information for virtually displaying the display apparatus 20 and the user's hand in the virtual space. In other words, the generation unit 160 generates display information for similarly displaying what is present in the real space even in the virtual space. Therefore, the generation unit 160 generates display information for displaying the image of the input unit 30, according to the actual size and shape of the input unit 30, based on the position and attitude of the input unit 30 determined by the determination unit 120. Therefore, the generation unit 160 generates display information for displaying the image of the user' s hand, according to the actual size and shape of the user's hand, based on the position and attitude of the user's hand determined by the determination unit 120. That is, the input unit 30 and the user's hand are displayed in the virtual space with the same sizes and shapes as in the real space.

That is, the generation unit 160 disposes the 3D models of the input unit 30, the user's hand, and the display apparatus 20 in the virtual space. At this time, in the virtual space, they are disposed in the same positions and attitudes as in the real space. Further, they are disposed with the same sizes and shapes as in the real space. However, it is not necessary for colors to be matched between the virtual space and the real space. In a case where there is additional information, they are also displayed on the sheet 31. Thus, the writing information input by the user is displayed on the sheet 31.

As shown in FIG. 2, the display apparatus 20 includes a display information acquisition unit 210 that acquires display information and an image display 220 that displays an image based on the display information.

The display information acquisition unit 210 acquires the image information generated by the generation unit 160. The image display 220 displays an image based on the image information generated by the generation unit 160. The image display 220 is, for example, the above-described display screen 20a.

Therefore, the screen displayed on the display apparatus 20 is the above-described virtual space, and the image display 220 virtually displays the input unit 30 in the virtual space according to the actual input unit 30. The same applies to the user's hand, and the image display 220 virtually displays the user's hand in the virtual space according to the actual user's hand.

Description of Operation of Information Processing System 1

Next, the operation of the information processing system 1 will be described.

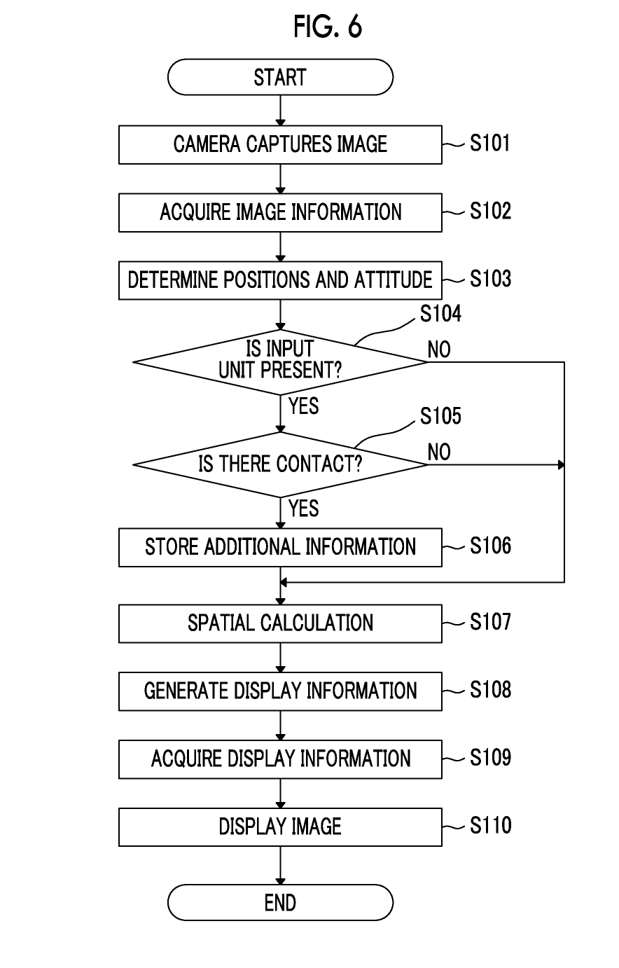

FIG. 6 is a flowchart for explaining an operation of the information processing system 1.

First, the camera 40 captures the image of the display apparatus 20, the input unit 30, the area setting sheet 50, and the user's hand (step 101). The image information of the captured image is transmitted to the information processing apparatus 10.

This image information is acquired by the image information acquisition unit 110 of the information processing apparatus 10 (step 102).

Next, the determination unit 120 determines the position and attitude of the input unit 30, based on the position of the marker or the like disposed in the input unit 30. Similarly, the determination unit 120 also determines the positions and attitudes of the display apparatus 20, the area setting sheet 50, and the user's hand (step 103).

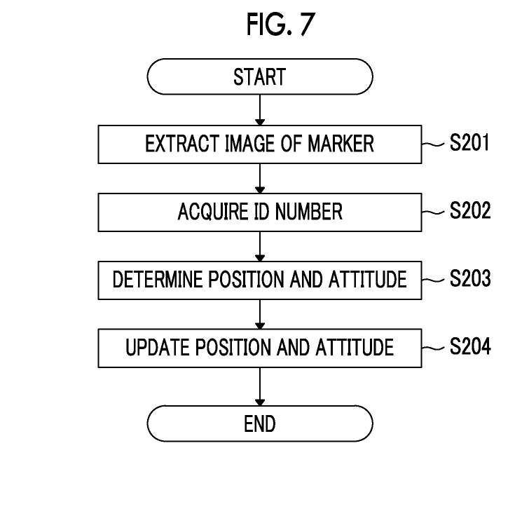

FIG. 7 is a flowchart for explaining a process in which the determination unit 120 determines the position and attitude of the input unit 30 or the like according to the position of the marker. FIG. 7 is a diagram for explaining the process of step 103 in more detail.

Here, first, a marker is extracted from the image (step 201). In a case where there are plural markers at this time, the image of each marker is extracted.

Then, the ID number is acquired from the extracted marker (step 202).

Further, based on the size and deformation state of the marker in the captured image, the position and attitude of the input unit 30 or the like are determined (step 203).

Then, information on the position and attitude of the input unit 30 or the like corresponding to the ID number is updated (step 204).

Returning to FIG. 6, the contact detection unit 140 determines whether or not the input unit 30 is included in the captured image, based on the ID number (step 104).

In a case where it is not included (No in step 104), the process proceeds to step 107.

In a case where it is included (Yes in step 104), the contact detection unit 140 detects that the plural input units 30 are in contact with each other or the input unit 30 and the user's hand are in contact with each other (step 105).

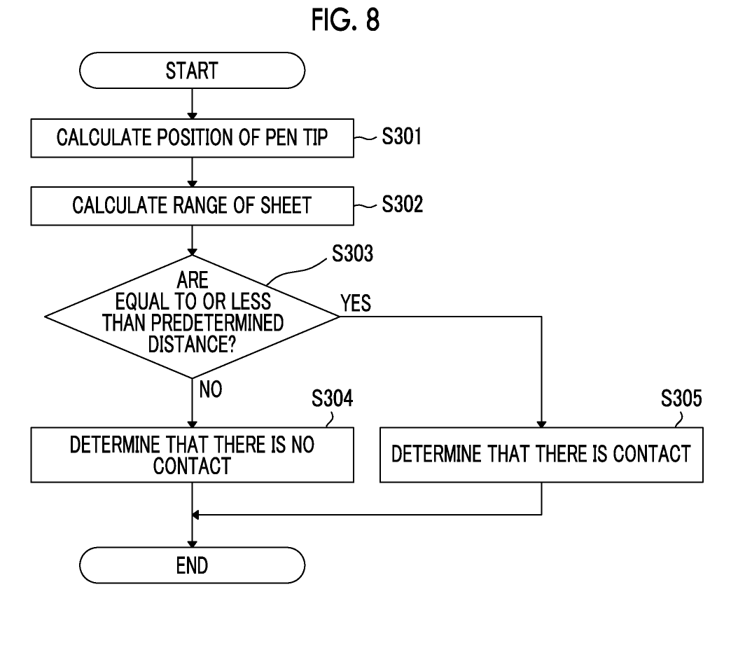

Hereinafter, the contact detection process performed by the contact detection unit 140 will be described with reference to FIGS. 8 to 11. FIG. 8 to FIG. 11 are diagrams for explaining the process of step 104 in more detail.

FIG. 8 is a flowchart for explaining a process of detecting that the sheet 31 and the pen 32 are in contact with each other as the plural input units 30.

The contact detection unit 140 calculates the position of the pen tip 32a, based on the position and attitude of the pen 32 and the size and shape of the pen 32 held by the holding unit 130 (step 301).

Next, the contact detection unit 140 calculates the range of the sheet 31, based on the position and attitude of the sheet 31 determined by the determination unit 120 and the size and shape of the sheet 31 held by the holding unit 130 (step 302).

Then, the contact detection unit 140 determines whether or not the position of the pen tip 32a and the range of the sheet 31 are equal to or less than the predetermined distance (step 303).

As a result, in a case where they are not equal to or less than the predetermined distance (No in step 303), the contact detection unit 140 determines that the sheet 31 and the pen 32 are not in contact (step 304).

On the other hand, in a case where they are equal to or less than the predetermined distance (Yes in step 303), the contact detection unit 140 determines that the sheet 31 and the pen 32 are in contact (step 305).

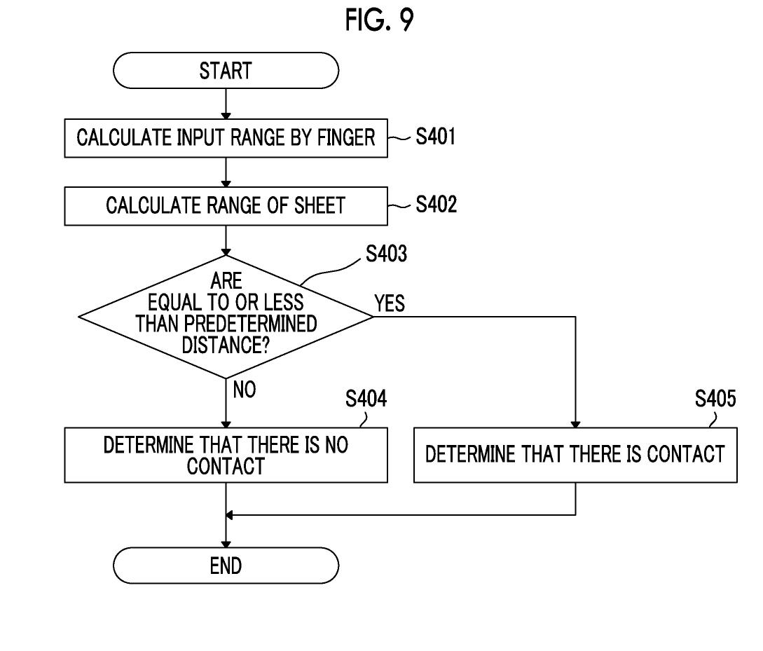

FIG. 9 is a flowchart for explaining a process of detecting that the input unit 30 and the user's hand are in contact with each other.

The contact detection unit 140 calculates the input range by the finger, based on the position and attitude of the user's hand and the size and shape of the user's hand held by the holding unit 130 (step 401).

Next, the contact detection unit 140 calculates the range of the sheet 31, based on the position and attitude of the sheet 31 and the size and shape of the sheet 31 held by the holding unit 130 (step 402).

Then, the contact detection unit 140 determines whether or not the input range by the finger and the range of the sheet 31 are equal to or less than the predetermined distance (step 403).

As a result, in a case where they are not equal to or less than the predetermined distance (No in step 403), the contact detection unit 140 determines that the sheet 31 and the user's hand are not in contact (step 404).

On the other hand, in a case where they are equal to or less than the predetermined distance (Yes in step 403), the contact detection unit 140 determines that the sheet 31 and the user's hand are in contact (step 405).

In addition, there is also a method of detecting a contact, by using a contact determination sensor such as a pressure sensor or a light sensor, which is provided on the pen tip 32a of the pen 32.

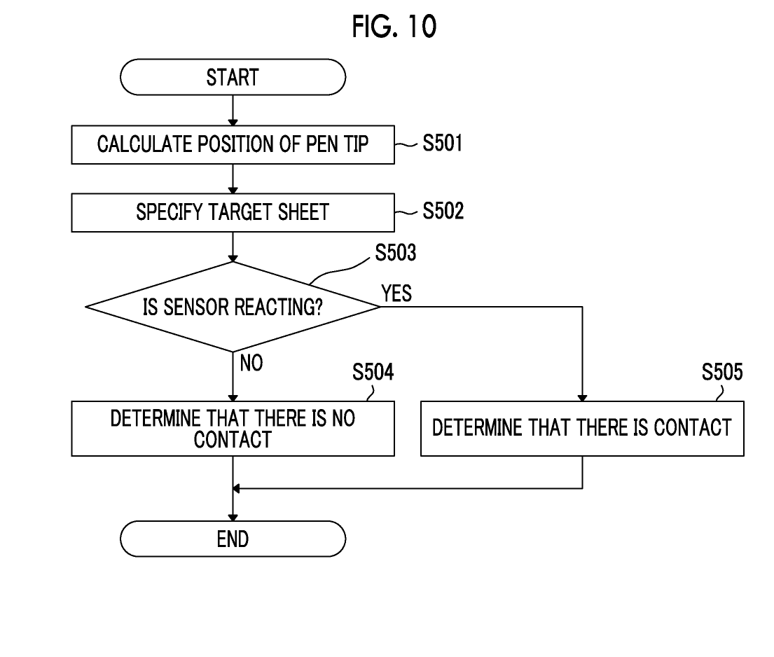

FIG. 10 is a flowchart for explaining a process of detecting that the sheet 31 and the pen 32 are in contact, by using a contact determination sensor which is provided on the pen tip 32a.

The contact detection unit 140 calculates the position of the pen tip 32a, based on the position and attitude of the pen 32 and the size and shape of the pen 32 held by the holding unit 130 (step 501).

Next, the contact detection unit 140 specifies a target sheet 31, by calculating the range of the sheet 31, based on the position and attitude of the sheet 31 determined by the determination unit 120 and the size and shape of the sheet 31 held by the holding unit 130 (step 502).

Then, the contact detection unit 140 determines whether or not the contact determination sensor provided on the pen tip 32a is reacting (step 503).

As a result, in a case where there is no reaction (No in step 503), the contact detection unit 140 determines that the sheet 31 and the pen 32 are not in contact (step 504).

On the other hand, in a case where there is reaction (Yes in step 503), the contact detection unit 140 determines that the sheet 31 and the pen 32 are in contact (step 505).

In this method, the contact detection unit 140 cannot detect that the sheet 31 and the user's hand are in contact with each other.

In addition, there is also a method of detecting a contact, by using a contact determination sensor such as a pressure sensor or a light sensor, which is provided on the sheet 31.

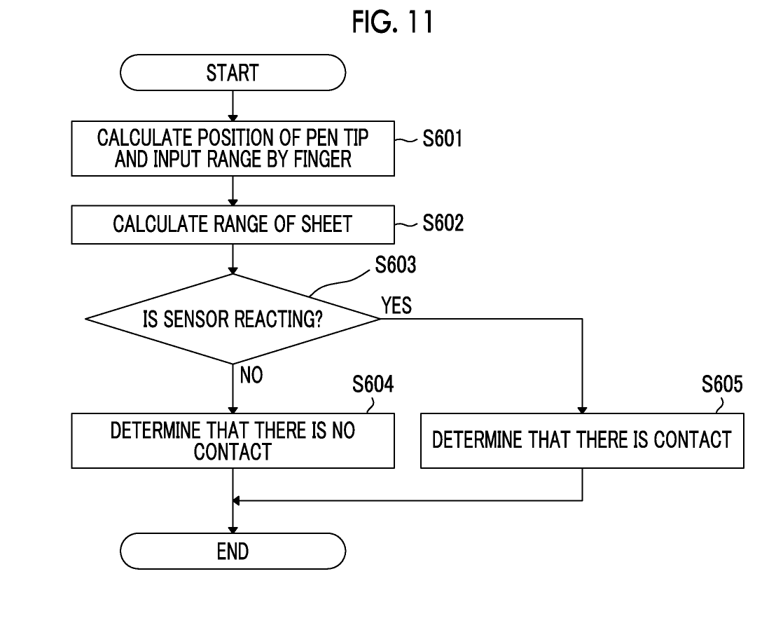

FIG. 11 is a flowchart for explaining a process of detecting that the sheet 31 and the pen 32 are in contact, by using the contact determination sensor which is provided on the sheet 31.

The contact detection unit 140 calculates the position of the pen tip 32a and the input range by the finger, based on the position and attitude of the pen 32 and the hand and the sizes and shapes of the pen 32 and the hand held by the holding unit 130 (step 601).

Next, the contact detection unit 140 calculates the range of the sheet 31, based on the position and attitude of the sheet 31 and the size and shape of the sheet 31 held by the holding unit 130 (step 602).

Then, the contact detection unit 140 determines whether or not the contact determination sensor provided on the sheet 31 is reacting (step 603).

As a result, in a case where there is no reaction (No in step 603), the contact detection unit 140 determines that the sheet 31 is not in contact with the pen 32 or the hand (step 604).

On the other hand, in a case where there is reaction (Yes in step 603), the contact detection unit 140 determines that the sheet 31 is in contact with the pen 32 or the hand and holds both the ID numbers (step 605).

Returning to FIG. 6 again, in a case where the contact detection unit 140 determines that contact has not been made (No in step 105), the process proceeds to step 107.

On the other hand, in a case where the contact detection unit 140 determines that the contact has been made (Yes in step 105), the storage unit 150 stores the information input by the input unit 30 or the user's hand as additional information (step 106).

Next, the generation unit 160 performs spatial calculation, and disposes the display apparatus 20, the input unit 30, the user's hand, the desk area, the image of the sheet 31, and the additional information as 3D models in the virtual space (step 107). The desk area is an area set by the area setting sheet 50. Further, the image of the sheet 31 is, for example, a format for the user to perform an input and is superimposed on the sheet 31. In this case, the additional information is the information input by the user in the format, and is further superimposed on the image of the sheet 31. That is, on the sheet 31, an image prepared in advance and an image of additional information in addition thereto are disposed.

Further, the generation unit 160 generates display information of the image to be displayed on the display apparatus 20 according to the position and attitude of the display apparatus 20 and presented to the user (step 108).

The display information generated by the generation unit 160 is transmitted to the display apparatus 20 and acquired by the display information acquisition unit 210 of the display apparatus 20 (step 109).

Then, the image display 220 displays the image on the display screen 20a based on the display information (step 110).

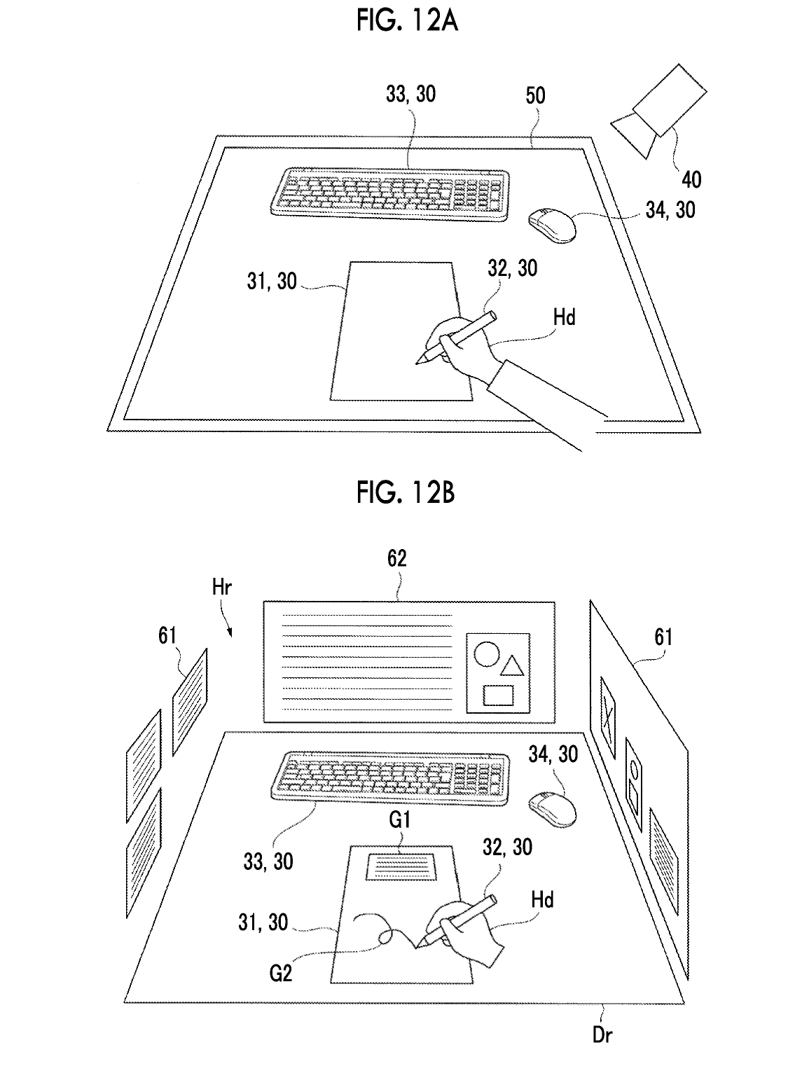

FIGS. 12A and 12B are diagrams for comparing a desktop state visually recognized by a user in a real space with a desktop state visually recognized by the user in a virtual space, in the present exemplary embodiment.

Here, FIG. 12A is a view of the input unit 30, the user's hand Hd and the area setting sheet 50 in the real space.

In FIG. 12A, in addition to the above-described sheet 31 and pen 32, a keyboard 33 and a mouse 34 are used as the input unit 30. It is shown that no information is described on the sheet 31 in the real space. Then, these are captured by the camera 40.

FIG. 12B is a diagram showing an image displayed on the display apparatus 20. Here, the case where the input unit 30, the user's hand Hd, and the desk area Dr are displayed in the virtual space is shown.

In FIG. 12B, the sheet 31, the pen 32, the keyboard 33 and the mouse 34 are displayed as the input units 30. Further, the desk area Dr set by the area setting sheet 50 and the user's hand Hd are displayed. In the real space, the input unit 30 is placed on the area setting sheet 50, so in the virtual space, it is displayed in the desk area Dr. In this case, the desk area Dr functions as a tactile area in which the user can use the input unit 30. Further, in this case, the image G2 of the additional information is superimposed and displayed on the sheet 31, in addition to the image G1 of the format for the user to perform input.

Further, in FIG. 12B, a non-tactile area Hr in which the input unit 30 cannot be used is disposed around the desk area Dr. Here, documents 61 to be displayed at all times in the virtual space are displayed on the left and right of the desk area Dr. The documents 61 to be displayed at all times are, for example, a calendar, a schedule table, and the like. A virtual display 62 is displayed on the front of the desk area Dr. On the display 62, information input by the user using the keyboard 33 and the mouse 34 is displayed as additional information. In the real world, even if there is only a small working space, it is possible to obtain a pseudo wide working space, by providing the non-tactile area Hr.

Explanation of Effect

The advantage of utilizing a paper medium for organizing, writing, proofreading, and other operations of documents is an operability that it is easy to handle the paper medium. On the other hand, in a tangible user interface by which unformed information can be directly touched (tactile, tangible), it is difficult to reproduce the operability and tactility (tangibility) of the paper medium. Further, in a case of working on documents on a PC, there is a problem that the work efficiency and the quality of work are likely to be lowered particularly outside the office. In other words, it takes time to move between documents, and simulation of necessary documents is required, so that the work efficiency and the work quality tend to decrease.

On the other hand, in the case of a paper medium, the user's intelligence is impeded in such that it is difficult to perform cooperation with other devices such as copy, paste, and search that can be done with PC, understand the work situation, change the display, or the like.

Here, according to the present exemplary embodiment, the input unit 30 existing in the real space is also displayed in the virtual space, and the document work or the like is performed by using the actually existing input unit 30. Thus, it is possible to obtain physical feedback also in the virtual space, so that a tactile (tangible) user interface can be realized. As a result, the user can work more naturally. Further, the size and shape of the input unit 30 displayed in the virtual space are reproduced substantially in the same manner as those in the real space. Therefore, for the user, it is possible that there is almost no inconsistency between the sense of touch when operating the input unit 30 displayed in the virtual space and the sense of touch when operating the actually existing input unit 30. Therefore, the user can handle the input unit 30 without feeling any discomfort. Further, since the existing input unit 30 can be selected, there is no need to learn a new operation method.

In a case of displaying the user's hand, since a visual sense is added, the sense of touch and the visual sense are more likely to match each other. In addition, by reproducing joint angles and the like of the fingers at this time, the display of the shape of the hand becomes more accurate, and the visual sense when the user views the hand and the sense of touch when operating the input unit 30 are not likely to be inconsistent.

Since the user performs operation using his/her own body, more flexible and prompt work can be performed, and the position storage for the input unit 30 can be easily utilized.

Further, in the present exemplary embodiment, the user inputs information by using the sheet 31 which is the sheet-type input unit 30 and the pen 32 which is the pen-type input unit 30. With this combination, it is possible to reproduce the operability of paper and pen in the reality. This makes it possible to reproduce operability such as spreading paper on the desk and quickly performing additional notes on the paper using the pen. In addition, as compared with the input device which presents pseudo-sense of touch by vibrations or the like in the related art, in the present exemplary embodiment, by using the actually existing input unit 30, a more accurate sense of touch including a reaction force can be presented and it also makes it easier to perform detailed operations necessary for work such as writing text. Further, in the present exemplary embodiment, it is also possible to enjoy the advantage of handling electronic information such as updating and changing information quickly.

By using the display apparatus 20 as a head mounted display, information can be displayed in a superimposed manner on the sheet 31 or the like regardless of the position and attitude of the input unit 30. Further, in this case, effects such as reduction in visual disturbance and noise are obtained, and the user is more likely to concentrate on the work.

Further, in the present exemplary embodiment, even in a case where the user is away from the office, it is easy to perform work with performance that is the same as that in a case where the user works at the office, and work can be performed in a narrow space.

In addition, the virtual space is more secure because the information displayed on the sheet 31 and the display 62 in the virtual space is not displayed in the real space.

Further, since paperless printing can be realized, it is easy to be able to totally take logging of work, make it possible to work at home, and cooperate with other devices such as copy and paste.

Further, because it is easier to make office less, there are advantages such as reduction of corporate assets, easiness of start-up of enterprises and launching of new projects, and employment of diverse human resources such as employment of remote human resources.

In the above-described exemplary embodiment, the area setting sheet 50 is prepared and the desk area Dr is set by this. However, the present invention is not limited thereto, and for example, LEDs setting the four corners of the desk area Dr may be disposed.

In the above-described embodiment, the display apparatus 20 performs display of the virtual space, that is, display using virtual reality (VR). However, the present invention is not limited to this, and augmented reality (AR) or mixed reality (MR) may be used.

Further, the document work is exemplified in the exemplary embodiment described above, but without being limited thereto, the present invention may be applied to simulation, game, or the like, for example.

Further, the input unit 30 is not limited to the above-mentioned ones. For example, as the input unit 30, there are a music stand for setting up a document, a calendar, a clock for displaying time, a clip or binder for bundling documents, a ruler, a compass, a coaster laid under a mug, a tablet terminal, a smartphone terminal, and the like may be prepared.

Explanation of Program

Here, the process performed by the information processing apparatus 10 in the present exemplary embodiment described above is prepared as a program such as application software.

Thus, the process performed by the information processing apparatus 10 in the present exemplary embodiment can be realized by a program causing a computer to execute an image information acquisition function of acquiring the image information of the input unit 30, from the camera 40 that captures the input unit 30 by which information is input, and a generation function of generating display information for the display apparatus 20 that displays an image of the input unit 30 based on the image information, in which the generation function updates the display information for the display apparatus 20, according to information which is input by using the input unit 30 displayed on the display apparatus 20.

Further, the program realizing the present exemplary embodiment can be provided not only by a communication unit but also by being stored in a recording medium such as a CD-ROM.

Although the present exemplary embodiment has been described above, the technical scope of the present invention is not limited to the scope described in the above exemplary embodiment. It is obvious from the description of the scope of the claims that various modifications or improvements to the above exemplary embodiment are also included in the technical scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an image information acquisition unit that acquires image information of an input unit, from an imaging apparatus that captures the input unit by which information is input; and
a generation unit that generates display information for a display apparatus that displays an image of the input unit based on the image information,
wherein the generation unit updates the display information for the display apparatus, according to information which is input by using the input unit displayed on the display apparatus.

2. The information processing apparatus according to claim 1,
wherein the input unit has a marker for determining a position and an attitude of the input unit,
the information processing apparatus further comprising:
a determination unit that determines the position and attitude of the input unit, based on image information of the marker which is captured by the imaging apparatus.

3. The information processing apparatus according to claim 2,
wherein the generation unit generates display information for displaying the image of the input unit, according to an actual size and an actual shape of the input unit, based on the position and the attitude of the input unit determined by the determination unit.

4. The information processing apparatus according to claim 3,
wherein the determination unit further determines a position and an attitude of a user's hand, and
wherein the generation unit generates display information for displaying an image of the user's hand, according to an actual size and an actual shape of the user's hand, based on the position and the attitude of the user's hand determined by the determination unit.

5. The information processing apparatus according to claim 1, further comprising:
a contact detection unit that detects that a plurality of the input units are in contact with each other or the input unit and the user's hand are in contact with each other.

6. The information processing apparatus according to claim 5,
wherein the generation unit generates display information for displaying information input by the plurality of input units being in contact with each other, as additional information.

7. The information processing apparatus according to claim 6, further comprising:
a storage unit that stores the additional information.

8. The information processing apparatus according to claim 1,
wherein the generation unit generates display information for virtually displaying the input unit existing in a real space, in a virtual space.

9. The information processing apparatus according to claim 8,
wherein the generation unit generates display information by separating a tactile area in which the user can use the input unit and a non-tactile area in which the user cannot use the input unit.

10. The information processing apparatus according to claim 9,
wherein the generation unit displays the input unit in the tactile area.

11. The information processing apparatus according to claim 9,
wherein the generation unit generates display information for displaying documents to be displayed at all times in the virtual space, in the non-tactile area.

12. A display apparatus comprising:
a display information acquisition unit that acquires display information for displaying an image of an input unit, based on image information of the input unit acquired from an imaging apparatus that captures the input unit by which information is input; and
an image display that displays the image based on the display information,
wherein the display information acquisition unit acquires display information which is updated according to information which is input by using the input unit displayed on the image display.

13. The display apparatus according to claim 12,
wherein the display apparatus is a head mounted display.

14. The display apparatus according to claim 12,
wherein the image display virtually displays the input unit in the virtual space according to the actual input unit.

15. An information processing system comprising:
an imaging apparatus that captures an input unit by which information is input;
a display apparatus that displays an image based on display information; and
an information processing apparatus that generates the display information,
wherein the information processing apparatus includes
an image information acquisition unit that acquires image information of the input unit from the imaging apparatus, and
a generation unit that generates display information for a display apparatus that displays an image of the input unit based on the image information, and
wherein the generation unit updates the display information for the display apparatus, according to information which is input by using the input unit displayed on the display apparatus.

16. The information processing system according to claim 15,
wherein the input unit includes a sheet-type input unit and a pen-type input unit, as a shape.

17. The information processing system according to claim 15, further comprising:
an area setting unit that determines a tactile area in which a work is tactually performed by using the input unit.
